(19) United States
(12) Patent Application Publication
(10) Pub. No.: US 2011/0205878 A1
(43) Pub. Date: Aug. 25, 2011

(54) LASER ATTACHMENT DEVICE AND OPTICAL PICK-UP DEVICE USING THE SAME

(75) Inventors: Ryoichi KAWASAKI, Isesaki-shi (JP); Mitsuhiro HASHIMOTO, Ota-shi (JP)

(73) Assignee: SANYO Electric Co., Ltd., Osaka (JP)

(21) Appl. No.: 13/029,860

(22) Filed: Feb. 17, 2011

(30) Foreign Application Priority Data
Feb. 19, 2010 (JP) 2010-034924

(51) Int. Cl. G11B 7/00; F21V 19/00

(52) U.S. Cl. 369/100; 362/382; G9B/7

(57) ABSTRACT

In a laser attachment device of the preferred embodiment of the invention, a pair of protruding portions are formed on a seating surface of a LD holder by which the position of a CAN package is fixed. The CAN package inserted in a through-hole comes into contact with the pair of protruding portions, and then is fixedly bonded to the inside of the LD holder while being inclined with the protruding portions being the starting point of the inclination. This structure allows the luminance adjustment of a laser beam to be performed without causing displacement of the emitting direction of the laser beam from an optical axis of an optical pick-up device. Thus, the laser attachment device having an improved workability and being suitable for mass production is achieved.

This application claims priority from Japanese Patent Application Number JP 2010-034924 filed on Feb. 19, 2010, the content of which is incorporated herein by reference in its entirety.

### BACKGROUND OF THE INVENTION

1. Field of the Invention

The present invention relates to a laser attachment device which facilitates adjustment of luminance distribution of a laser beam, and to an optical pick-up device using the same.

2. Description of the Related Art

As an embodiment of a conventional laser attachment device, a structure shown in FIG. 6 is known. As shown in the drawing, an optical axis adjustment mechanism part 42 is disposed on a base 41 of the laser attachment device. The optical axis adjustment mechanism part 42 is formed of a fixed seat 43 and a movable seat 44. An opening region 45 is formed in the fixed seat 43, and the inner surface of the opening region 45 is processed into a spherical surface centered at an optical axis 46 of an optical system. Meanwhile, the outer circumferential surface of the movable seat 44 is similarly processed into a spherical surface centered at the optical axis 46 of the optical system. A LD package 48 is disposed in close contact with a reference surface 47 of the movable seat 44, and the movable seat 44 is fitted into the opening region 45 of the fixed seat 43. Then, the position of the movable seat 44 is adjusted by an optical axis adjustment machine 49. Thus, the emitting direction of the laser beam emitted from the LD package 48 and the optical axis 46 of the optical system are adjusted. Displacement in luminance distribution of the laser beam on an objective lens (not shown) is also adjusted in a similar manner by the position adjustment of the movable seat 44. Note that, after the optical axis and the luminance distribution are adjusted, positional relationship between the fixed seat 43 and the movable seat 44 is fixed by an adhesive 50 (see for example, Japanese Patent Application Publication No. Hei 5-81693 pages 3 to 4, FIGS. 1 and 2).

As described above, in the conventional laser attachment device, the optical axis and the luminance distribution of the laser beam are adjusted by adjusting the position of the movable seat 44 for each of laser attachment devices after the optical axis adjustment mechanism part 42 is fixed to the base 41 of the laser attachment device. Accordingly, there are problems that the time required to attach and adjust the laser attachment device is difficult to reduce, working efficiency is poor, the laser attachment device is not suitable for mass production, and improvement in yield is difficult to achieve.

In addition, the adjustment of the laser beam requires fine movement of the movable seat 44 with respect to the fixed seat 43, and thus requires technique of a skilled worker. Accordingly, there is a problem of variation in adjustment accuracy depending on the skill of a worker.

### SUMMARY OF THE INVENTION

A laser attachment device of the preferred embodiment of the invention includes: a package to which a laser diode emitting a laser beam is fixedly attached; and a holder holding the package. In the laser attachment device, a through-hole in which the package is housed is formed in the holder, a seating surface for fixing a position of the package is formed inside the through-hole, and a pair of protruding portions are formed on the seating surface in such a manner as to be arranged symmetrically with respect to a center axis of the through-hole.

In the preferred embodiment of the invention, the pair of protruding portions are arranged on the seating surface of the holder, and the CAN package is fixedly attached in the holder while being inclined using the protruding portions. This structure facilitates the adjustment of the luminance distribution of the laser beam, and the working efficiency is improved.

Also in the preferred embodiment of the invention, since the method of fixedly attaching the CAN package using the pair of protruding portions is applied, the CAN package is sorted as being either one of two types depending on variation in luminance distribution. This structure facilitates the method of fixedly attaching the CAN package, and the workability is improved.

Furthermore in the preferred embodiment of the invention, a single type of holder can handle two types of CAN package which are different in luminance distribution characteristics of the laser beam. Thus, simple errors, such as a case where a worker mistakenly uses a wrong holder, are eliminated, and yield is improved.

Moreover in the preferred embodiment of the invention, the rotation axis of the CAN package is fixed by the protruding portions. Thus, the light emitting point of the laser beam is not displaced from the optical axis.

Furthermore in the preferred embodiment of the invention, a surface of the holder, through which the holder is fixedly attached to a housing, and the seating surface of the holder are perpendicular to the optical axis. Thus, the holder is easily fixed to the housing.

Moreover in the preferred embodiment of the invention, a laser attachment device with the above described structure is used to achieve an optical pick-up device excellent in workability, productivity, and yield.

### BRIEF DESCRIPTION OF THE DRAWINGS

FIG. 1A is a perspective view illustrating a laser attachment device of an optical pick-up device according to a preferred embodiment of the invention, and FIG. 1B is a perspective view illustrating the same.

FIG. 2A is a plan view illustrating the laser attachment device of the optical pick-up device according to the preferred embodiment of the invention, FIG. 2B is a plan view illustrating the same, and FIG. 2C is a cross-sectional view illustrating the same.

FIG. 3 is a schematic view illustrating an optical system of the optical pick-up device according to the preferred embodiment of the invention.

FIG. 4A is a view illustrating a luminance distribution of a laser beam of the optical pick-up device according to the preferred embodiment of the invention, FIG. 4B is a view illustrating variation in luminance distribution.

FIG. 5A is a cross-sectional view illustrating the laser attachment device of the optical pick-up device according to the preferred embodiment of the invention, and FIG. 5B is a cross-sectional view illustrating the same.

FIG. 6 is a cross-sectional view illustrating a laser attachment device according to a conventional embodiment.

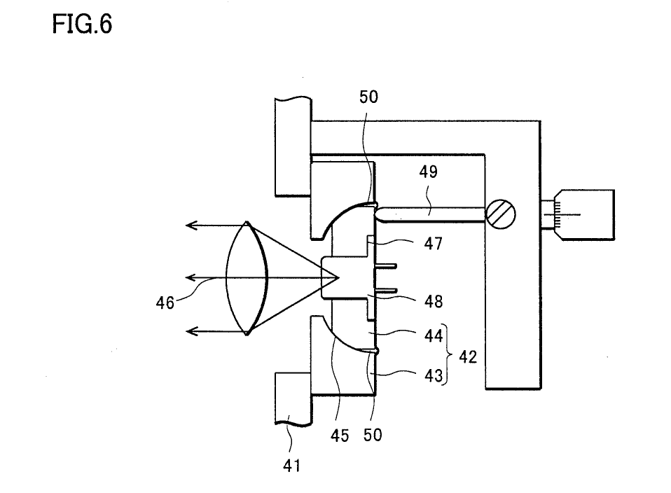

### DESCRIPTION OF THE INVENTION

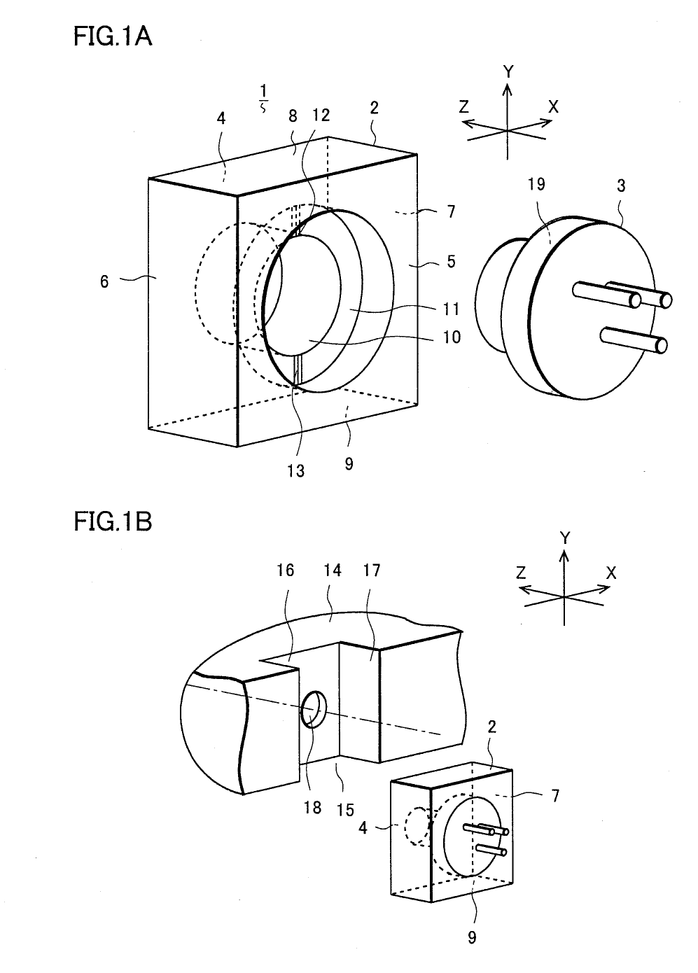

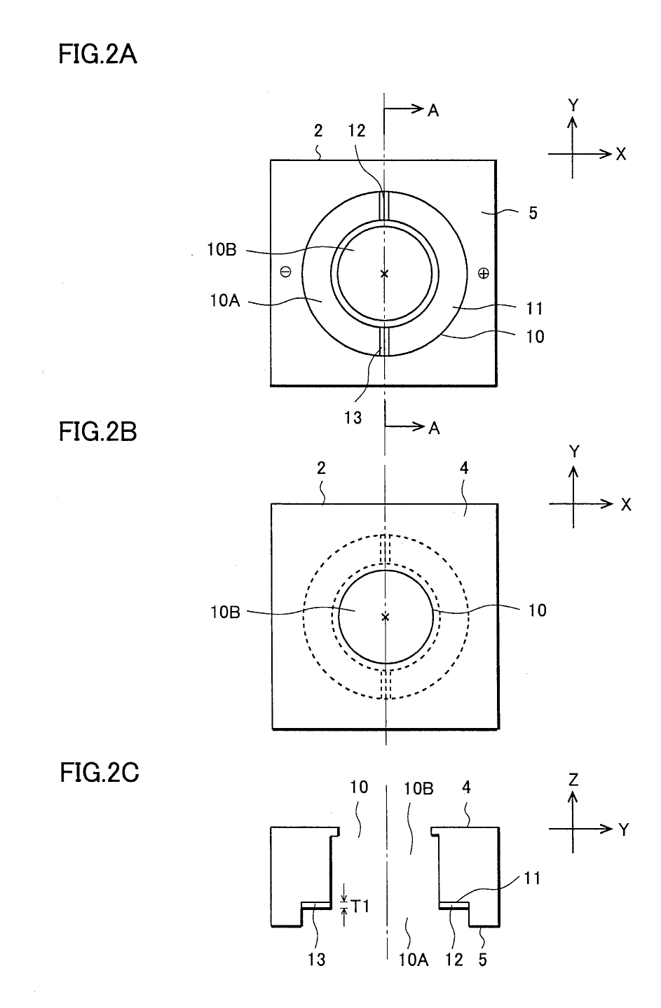

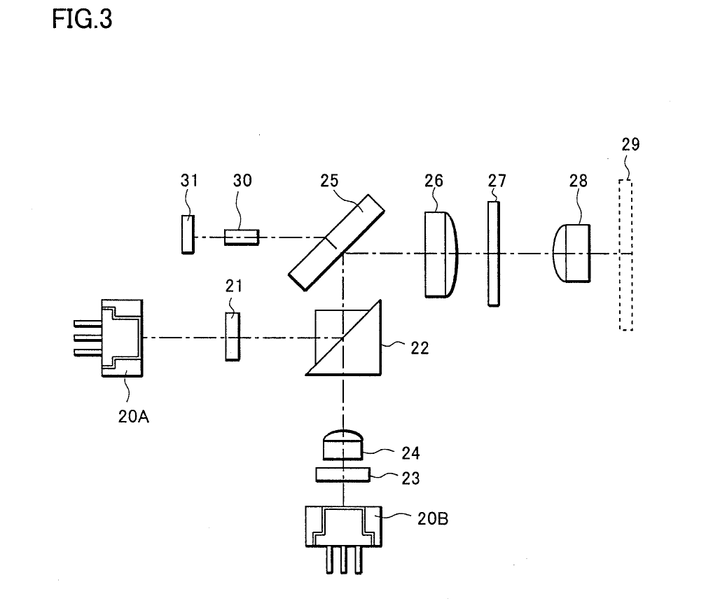

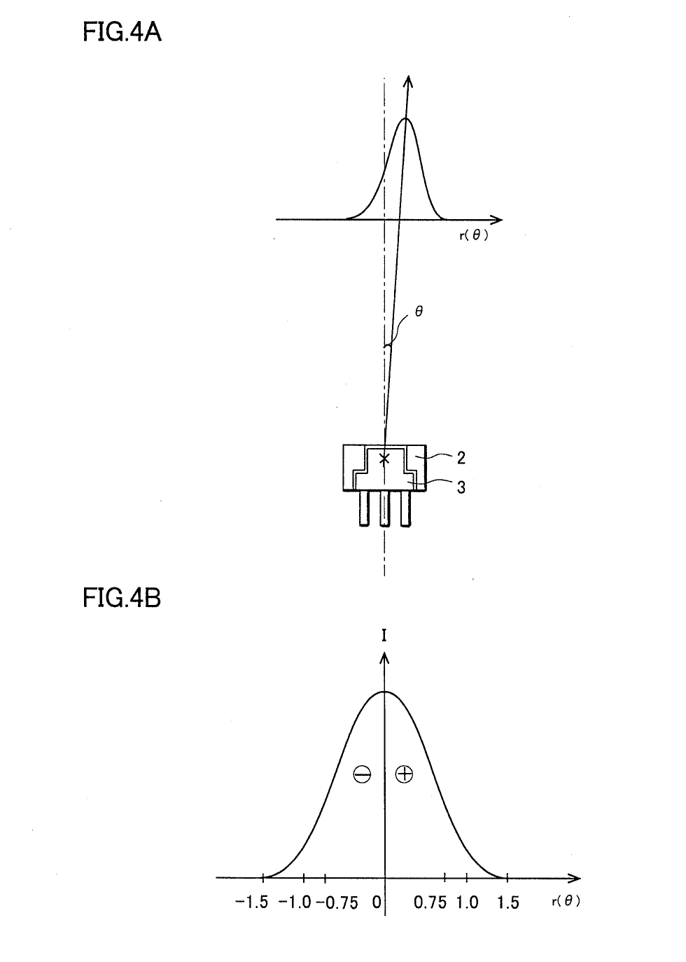

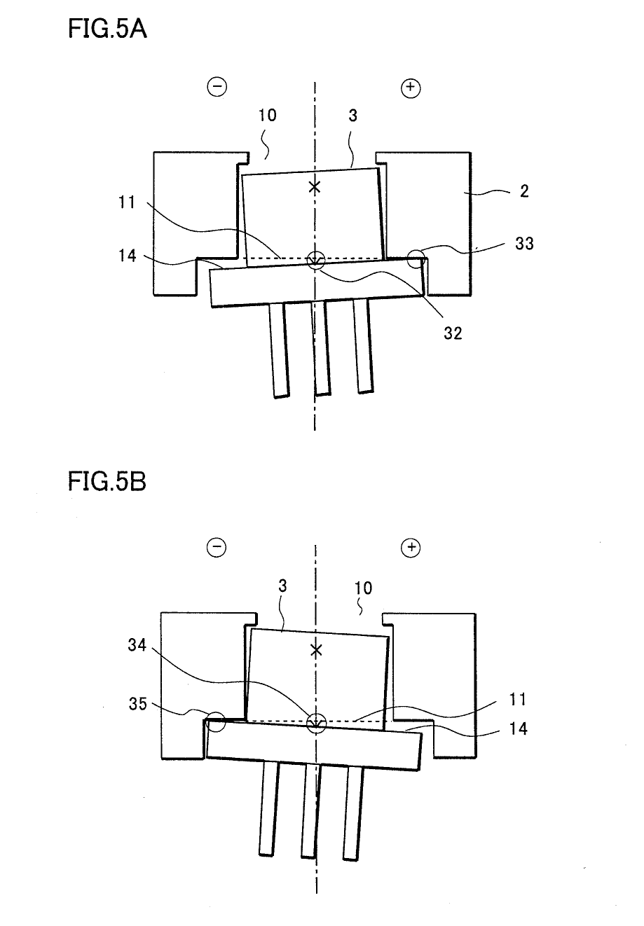

A description will be given below of a laser attachment device being a preferred embodiment of the invention and an optical pick-up device using the same. FIG. 1A is a perspective view illustrating a laser diode (LD) holder and a CAN package which constitute the laser attachment device. FIG. 1B is a perspective view illustrating a housing and the LD holder. FIGS. 2A to 2C are views illustrating the LD holder shown in FIG. 1A. FIG. 3 is a schematic view illustrating an optical system of the optical pick-up device. FIGS. 4A and 4B are views illustrating a luminance distribution of a laser beam. FIGS. 5A and 5B are views illustrating the CAN package fixedly attached in the LD holder.

As shown in FIG. 1A, a laser attachment device 1 is formed mainly of a LD holder 2 and a CAN package 3 to be fixedly attached to the LD holder 2. Although not illustrated, a LD, a LD driver (LDD), and the like are disposed in the CAN package 3, and a laser beam is emitted from the LD by causing the current to flow from the LDD to the LD. Although described in detail later, the laser beam emitted from the LD is focused on an optical information recording medium and is then reflected to write and read data into and from the optical information recording medium. Thus, the LD holder 2 is arranged in a housing 14 (see FIG. 1B) in such a manner that the emitting direction of the laser beam coincides with the optical axis of the optical pick-up device with high accuracy. Note that, the housing 14 refers to a package with optical system parts shown in FIG. 3 built in. For example, the LD holder 2 is disposed inside the housing 14, on the side surface of the housing 14, or the like.

In the following description, a X-axis direction in the drawings corresponds to the width direction of the housing (width direction of the LD holder), a Y-axis direction in the drawings corresponds to the height direction of the housing (height direction of the LD holder), and a Z-axis direction in the drawing corresponds to the length direction of the housing (length direction of the LD holder). Note that, the Z-axis direction in the drawing coincides with the optical axis direction of the optical pick-up device, and also coincides with the emitting direction of the laser beam emitted from the inside of the LD holder.

The LD holder 2 is a rectangular solid, and side surfaces 4 and 5 of the LD holder 2 are reference surfaces in the XY direction with respect to the optical axis direction, and are perpendicular to the optical axis direction. Moreover, side surfaces 6 and 7 are reference surfaces in the YZ direction with respect to the optical axis direction, and side surfaces 8 and 9 are reference surfaces in the XZ direction with respect to the optical axis direction. A through-hole 10 having the same shape as the CAN package 3 is formed in the LD holder 2 to penetrate from the side surface 4 to the side surface 5 on the opposite side. A seating surface 11 by which the position of the CAN package 3 is fixed is formed in the through-hole 10. The seating surface 11 is a reference surface in the XY direction parallel to the side surfaces 4 and 5. Protruding portions 12 and 13 are formed at two positions on the seating surface 11. Although described in detail later, the CAN package 3 is fixedly attached inside the LD holder 2 to be slightly inclined with respect to the optical axis direction with the protruding portions 12 and 13 being the starting point of inclination.

As shown in FIG. 1B, for example, a recess portion 15 with a shape matching the shape of the LD holder 2 is formed in a region of the housing 14 to which the LD holder 2 is to be attached. A side surface 16 in the recess portion 15 is a reference surface in the XY direction with respect to the optical axis direction, and a side surface 17 in the recess portion 15 is a reference surface in the YZ direction with respect to the optical axis direction. An opening portion 18 is formed in the side surface 16 to correspond to the through-hole 10 of the CAN package 3. The center axis of the opening portion 18 coincides with the optical axis direction of the optical pick-up device as shown in a dash-dotted line. The laser beam emitted from the inside of the LD holder 2 travels through the opening portion 18, along the optical axis shown in the dash-dotted line.

A method of attaching the LD holder 2 to the housing 14 will be described. Firstly, the side surface 4 of the LD holder 2 is brought into contact with the side surface 16 of the housing 14. Thus, the surfaces perpendicular to the optical axis direction of the optical pick-up device (reference surfaces in the XY direction) are fixed. Note that, at this time, the side surface 9 of the LD holder 2 is brought into contact with the housing 14, and the reference surfaces in the XZ direction are also fixed. Thereafter, the LD holder 2 is moved horizontally in the X-axis direction, and the side surface 7 of the LD holder 2 is brought into contact with the side surface 17 of the housing 14. Thus, the reference surfaces in the YZ direction are fixed. Then, the LD holder 2 is moved horizontally in the Z-axis direction, and is press fitted into the housing 14. Thus, the LD holder 2 is fixedly attached to the housing 14. In other words, the LD holder 2 and the housing 14 are designed so that the emitting direction of the laser beam emitted from the inside of the LD holder 2 coincides with the optical axis of the optical pick-up device with high accuracy by performing the above-described simple attachment work.

FIG. 2A shows a plan view of the LD holder 2 viewed from the side surface 5 side. The through-hole 10 has the same shape as the CAN package 3 (see FIG. 1A), and is a space slightly larger than the CAN package 3. A cross mark illustrated on the center axis of the through-hole 10 is a light emitting point of the laser beam, and coincides with the optical axis of the optical pick-up device. Moreover, the seating surface 11 being the reference surface in the XY direction with respect to the optical axis direction is formed in the through-hole 10, and is formed in a ring shape on the inner circumference side of the through-hole 10. The seating surface 11 is used as a surface for fixing the position of the CAN package 3. The paired protruding portions 12 and 13 are formed on the seating surface 11.

A dash-double-dotted line in the drawing is perpendicular to the optical axis, and is the center axis of the through-hole 10 in the Y-axis direction. The protruding portions 12 and 13 are arranged on this center axis. A seating surface 19 of the CAN package 3 (see FIG. 1A) comes into contact with the protruding portions 12 and 13, and thus the CAN package 3 is press fitted into and bonded to the LD holder 2 in a state of being inclined to the right (positive direction of X axis) or left (negative direction of X axis) in the drawings with the protruding portions 12 and 13 being the starting point of inclination. This structure causes the CAN package 3 to be inclined to the right or left in the drawings about the center axis shown in the dash-double-dotted line being the rotation axis, and thereby the luminance adjustment of the laser beam is performed. At this time, the CAN package 3 is fixedly bonded to the inside of the LD holder 2 while being pressed against the inner side surface of the LD holder 2, the inner side surface being on the side (positive or negative direction of X axis) to which the CAN package 3 is inclined, so that the light emitting point of the laser beam is not displaced from the optical axis of the optical pick-up device. Note that, the seating surface 19 of the CAN package 3 is also the reference surface in the XY direction with respect to the optical axis direction.

Moreover, the side surface 5 of the LD holder 2 has a “+” mark printed by laser printing at a position on the right side (positive direction of the X axis) of the center axis shown in the dash-double-dotted line in the drawing, and a “−” mark printed by laser printing at a position on the left side (negative direction of the X axis) thereof. Although described in detail later, a worker fixedly attaches the CAN package 3 in a state where the CAN package 3 is inclined to either side in accordance with the luminance distribution characteristics of the laser beam emitted from the inside of the CAN package 3.

FIG. 2B shows a plan view of the LD holder 2 viewed from the side surface 4 side. As shown in the drawing, the through-hole 10 is disposed in the side surface 4, and the light emitting point of the laser beam indicated by the cross mark is positioned on the center axis of the through-hole 10.

FIG. 2C shows the cross-sectional view of the LD holder 2 taken along the A-A line shown in FIG. 2A. As shown in the drawing, the through hole 10 is substantially the same shape as the CAN package 3, and has a shape formed by combing two columnar spaces 10A and 10B. Since the CAN package 3 is inserted into the LD holder 2 from the side surface 5 side, the diameter of the columnar space 10A is larger than that of the columnar space 10B. The dash-dotted line in the drawing shows the optical axis of the optical pick-up device, and the light emitting point of the laser beam indicated by the cross mark is positioned on the optical axis. The inclined angle of the CAN package 3 is adjusted in accordance with the height t1 of the protruding portions 12 and 13 formed on the seating surface 11. Note that, design changes can be made on the height t1 of the protruding portions 12 and 13 as desired in accordance with the application.

The optical system of the optical pick-up device will be described using FIG. 3. The dash-dotted line in the drawing shows the optical axis of the optical pick-up device, and optical system parts described below are arranged accurately at their positions with respect to the optical axis.

A first LD holder 20A emits a laser beam of a first wavelength (blue-violet (blue) wavelength band of 400 nm to 420 nm (for example 405 nm)). A second LD holder 20B emits a laser beam of a second wavelength (red wavelength band of 645 nm to 675 nm (for example 655 nm)) and a laser beam of a third wavelength (infrared wavelength band of 765 nm to 805 nm (for example 785 nm)). Note that, the structure of the above-described LD holder 2 is applied to the first and second LD holders 20A and 20B.

A first diffraction grating 21 is disposed between the first LD holder 20A and a polarization beam splitter 22, and the laser beam emitted from the first LD holder 20A enters the first diffraction grating 21. The first diffraction grating 21 is formed of a diffraction grating which splits the entering laser beam into a zero-order beam, a positive first order diffracted beam, and a negative first order diffracted beam, and a half-wave plate which changes the entering laser beam into a linearly polarized beam with S-polarization with respect to the polarization plane of the polarization beam splitter 22. Likewise, a second diffraction grating 23 is disposed between the second LD holder 20B and the polarization beam splitter 22, and is formed of a diffraction grating and a half-wave plate. Note that, in the second diffraction grating 23, the entering laser beam is changed into a linearly polarized beam with P-polarization with respect to the polarization plane of the polarization beam splitter 22.

A coupling lens 24 is arranged between the second diffraction grating 23 and the polarization beam splitter 22, and changes the divergence angle of the entering laser beam. As shown in the drawing, use of the coupling lens 24 allows a collimating lens 26 and an objective lens 28 to be used commonly for multiple laser beams. The polarization beam splitter 22 reflects the laser beam with S-polarization entering from the first diffraction grating 21, and transmits the laser beam with P-polarization entering from the coupling lens 24.

A semitransparent mirror 25 reflects, toward the collimating lens 26, the laser beam with S-polarization which is reflected by the polarization beam splitter 22 and then enters the semitransparent mirror 25 and the laser beam with P-polarization which is transmitted through the polarization beam splitter 22 and then enters the semitransparent mirror 25. Moreover, the semitransparent mirror 25 transmits returning beams of the laser beams, the returning beams entering from the collimating lens 26. The collimating lens 26 changes the laser beams entering from the semitransparent mirror 25 into collimated beams. The laser beams changed into the collimated beams by the collimating lens 26 enter a quarter-wave plate 27.

The quarter-wave plate 27 changes the laser beams entering from the collimating lens 26 from linearly polarized beams to circularly polarized beams. In addition, the quarter-wave plate 27 changes returning beams of the laser beams from circularly polarized beams to linearly polarized beams, the returning beams entering from the objective lens 28. Then, the objective lens 28 focuses the laser beams entering from the quarter-wave plate 27 onto respective corresponding signal recording layers of an optical information recording medium 29.

Returning beams of the laser beams reflected by the optical information recording medium 29 are changed into collimated beams by the objective lens 28, enter the quarter-wave plate 27, and are changed from circularly polarized beams to linearly polarized beams by the quarter-wave plate 27. Thereafter, the returning beams of the laser beams which are changed into linearly polarized beams are transmitted through the collimating lens 26, transmitted through the semitransparent mirror 25, and then enter a detection lens 30.

The detection lens 30 focuses the returning beams of the laser beams on an optical detector 31, and also causes astigmatism in the returning beams of the laser beams to generate a focus error signal. Then, the optical detector 31 performs photoelectric conversion of the received returning beams of the laser beams.

As shown in FIG. 4A, the laser beam emitted from the inside of the CAN package 3 travels along the optical axis of the optical pick-up device, the optical axis shown in a dash-dotted line. However, there are some cases where the luminance center of the laser beam is slightly inclined with respect to the optical axis. The reason for this inclination is thought to be due to the thickness and the unevenness of adhesive used to fixedly attach the LD in the CAN package 3. Furthermore, since the laser beam emitted from the inside of the CAN package 3 is focused on the optical information recording medium 29 by the objective lens 28, variation in luminance center of the laser beam may cause deterioration in focusing accuracy of the objective lens 28. Such case will be described below by using the positive direction and negative direction in the X-axis direction on the XY plane perpendicular to the optical axis, where r (θ) represents an angle by which the luminance center of the laser beam is displaced with respect to the optical axis.

Firstly, as shown in FIG. 4B, when the variation in luminance center of the laser beam emitted from the inside of the CAN package 3 is within a range of −1.5°≦r(θ)≦1.5°, there is hardly no effect on focusing accuracy, and is within a range of allowable error. Thus, such CAN package 3 is graded as non-defective. Then, the CAN package 3 thus graded as being within the range of allowable error is sorted as being either the CAN package 3 with a displacement in the positive direction (for example, 0°≦r(θ)≦1.5°) with respect to the optical axis or the CAN package 3 with a displacement in the negative direction (for example, −1.5≦r(θ)<0°) with respect to the optical axis.

As shown in FIG. 5A, the CAN package 3 with the displacement in the positive direction (for example, 0°≦r(θ)≦1.5°) is fixedly bonded to the inside of the LD holder 2 in a state of being inclined in the positive direction (see FIG. 2A) of the LD holder 2 by using the protruding portions 12 and 13 of the LD holder 2 shown in a circle 32. Accordingly, the inclination is adjusted by 0.5° in the negative direction by the height of the protruding portions 12 and 13, and thus the variation in luminance center of the laser beam of the CAN package 3 is adjusted to be within a range of −0.5°≦r(θ)≦1.0°. As a result, the CAN package 3 is fixedly attached to the inside of the LD holder 2 with the variation thereof within a range more accurate than the range of allowable error (−1.5°≦r(θ)≦1.5°) to be graded as being non-defective. Note that, as described above, when the structure of the protruding portions 12 and 13 of the LD holder 2 is used and the CAN package 3 is fixedly bonded to the inside of the LD holder 2 while being pressed against the inner side surface of the LD holder 2 on the positive direction side, the light emitting point in the CAN package 3 shown by the cross mark is not displaced from the optical axis. Moreover, as shown in circles 32 and 33, the CAN package 3 is fixed to the seating surface 11 of the LD holder 2 while being supported thereon at at least three points of the protruding portions 12 and 13 and part of the seating surface 11, and thus is fixedly attached stably.

Meanwhile, as shown in FIG. 5B, the CAN package 3 with the displacement in the negative direction (for example, (−1.5°≦r(θ)<1.5°) is fixedly bonded to the inside of the LD holder 2 in a state of being inclined in the negative direction (see FIG. 2A) of the LD holder 2 by using the protruding portions 12 and 13 of the LD holder 2 shown in a circle 34. Accordingly, the inclination is adjusted by 0.5° in the positive direction by the height of the protruding portions 12 and 13, and thus the variation in luminance center of the laser beam of the CAN package 3 is adjusted to be within a range of −1.5°≦r(θ)<1.5°. As a result, the CAN package 3 is fixedly attached to the inside of the LD holder 2 with the variation thereof within a range more accurate than the range of allowable error (−1.5°≦r(θ)≦1.5°) to be graded as being non-defective. Note that, as described above, when the structure of the protruding portions 12 and 13 of the LD holder 2 is used and the CAN package 3 is fixedly bonded to the inside of the LD holder 2 while being pressed against the inner side surface of the LD holder 2 on the negative direction side, the light emitting point in the CAN package 3 shown by the cross mark is not displaced from the optical axis. Moreover, as shown in circles 34 and 35, the CAN package 3 is fixed to the seating surface 11 of the LD holder 2 while being supported thereon at at least three points, and thus is fixedly attached stably.

In other words, in this embodiment, luminance adjustment is performed uniformly even on the CAN package 3 which requires no adjustment of the luminance center. However, the embodiment allows omission of all luminance adjustments after the LD holder 2 is fixedly attached to the housing 14. Accordingly, manufacturing is not affected by the skill of an individual worker. Thus, workability is improved and the LD holder 2 with excellent productivity is achieved. Moreover, since the single type of LD holder 2 can handle the CAN package 3 displaced in either direction, simple errors, such as a case where a worker mistakenly uses the wrong LD holder 2, are eliminated, and yield is improved.

Note that, in this embodiment, the description has been made of a case where luminance adjustment of 0.5° is made on the CAN package 3 with the variation within the range of −1.5°≦r(θ)≦1.5°, by adjusting the height t1 of the protruding portions 12 and 13 of the LD holder 2. However, it is not limited to this case. For example, the height t1 of the protruding portions 12 and 13 of the LD holder 2 can be made even higher to set the adjustment angle to 1.0°. In such case, the variation in luminance center can be suppressed within a range of −1.5°≦r(θ)≦1.5°, and further improvement in focusing accuracy is achieved. Further, by setting the adjustment angle to 1.0°, the CAN package 3 whose variation in luminance center of the laser beam emitted from the inside of the CAN package 3 is within a −2.0°≦r(θ)≦2.0°can also be handled as being non-defective, and thus yield is enhanced greatly with a simple attachment work. In other words, design changes on the height t1 of the protruding portions 12 and 13 can be made as desired in accordance with the properties of a laser beam to be handled and required focusing accuracy.

In addition, the description has been made of a case where the CAN package 3 is sorted as being any one of two types, that is the CAN package 3 with a displacement in the positive direction and the CAN package 3 with a displacement in the negative direction. However, it is not limited to this case. For example, the CAN package 3 can be sorted as being any one of three types, that is the above-described two types and the CAN package 3 which requires no luminance adjustment. A LD holder with no protruding portions 12 and 13 disposed thereon is used for the CAN package 3 sorted as one not requiring luminance adjustment, and thus further improvement in focusing accuracy is achieved. Various other changes can be made within a scope not departing from the gist of the invention.

What is claimed is:

1. A laser attachment device comprising:
a package to which a laser diode emitting a laser beam is fixedly attached; and
a holder holding the package, wherein
a through-hole in which the package is housed is formed in the holder,
a seating surface for fixing a position of the package is formed inside the through-hole, and
a pair of protruding portions are formed on the seating surface in such a manner as to be arranged symmetrically with respect to a center axis of the through-hole.

2. The laser attachment device according to claim 1, wherein
the center axis of the through-hole coincides with an optical axis of the holder,
the seating surface is perpendicular to the optical axis, and
the pair of protruding portions are arranged in a height direction of the holder, the height direction being perpendicular to the optical axis.

3. The laser attachment device according to claim 2, wherein the package is sorted in accordance with an inclination of a luminance center of the laser beam in a width direction of the holder with respect to the optical axis, the laser beam emitted from the inside of the package.

4. The laser attachment device according to any one of claims 2 and 3, wherein
the package is fixed while being in contact with at least the pair of protruding portions and part of the seating surface, and
a light emitting point of the laser diode is located on the optical axis.

5. The laser attachment device according to any one of claims 2 and 3, wherein
the holder is a rectangular solid, and
a pair of side surfaces, through which the through-hole penetrates, of the rectangular solid are parallel to the seating surface.

6. An optical pick-up device which performs at least writing or reading of data into or from an optical information recording medium by using a laser beam emitted from a laser attachment device, wherein
the laser attachment device is the laser attachment device according to any one of claims 1 to 5.
